(19) United States
(12) Patent Application Publication
(10) Pub. No.: US 2023/0408984 A1
(43) Pub. Date: Dec. 21, 2023

(54) PORTABLE ELECTRONIC DEVICE WITH HAPTIC BUTTON

(71) Applicant: Apple Inc., Cupertino, CA (US)

(72) Inventors: Jiahui Liang, Sunnyvale, CA (US); Andrew L. Doyle, Cupertino, CA (US)

(21) Appl. No.: 17/845,872

(22) Filed: Jun. 21, 2022

(51) Int. Cl. G04G 21/08; G08B 6/00

(52) U.S. Cl. CPC G04G 21/08; G08B 6/00

(57) ABSTRACT

An electronic watch includes a housing member defining a hole along a side surface of the housing member, and a haptic button. The haptic button may include an input member positioned at least partially within the hole and defining an input surface, a magnet configured to generate a magnetic field, and a conductive coil coupled to the input member and positioned at least partially within the magnetic field. The electronic watch may further include a processing unit configured to cause an electrical current to pass through the conductive coil, thereby moving the input member along a translation direction perpendicular to the input surface to produce a haptic output. The conductive coil may be fixed to an interior surface of the input member.

### FIELD

The subject matter of this disclosure relates generally to electronic devices and, more particularly, to electronic devices with haptic button assemblies configured to receive inputs and provide haptic outputs at an electronic device.

### BACKGROUND

Modern consumer electronic devices may include various buttons or input devices that are used to control the device or provide user input. For example, buttons can be pushed (e.g., translated) in order to provide an input to the device. Rotational input devices may be rotated or twisted in order to provide an input to the device. Input devices may provide tactile feedback to a user to indicate that an input has been effectively provided. For example, buttons may use tactile dome switches that produce a tactile “click” when the button is pressed. Rotational input devices may click (e.g., due to internal gearing) when rotated to indicate that the input device has been rotated.

### SUMMARY

An electronic watch includes a housing member defining a hole along a side surface of the housing member, and a haptic button. The haptic button may include an input member positioned at least partially within the hole and defining an input surface, a magnet configured to generate a magnetic field, and a conductive coil coupled to the input member and positioned at least partially within the magnetic field. The electronic watch may further include a processing unit configured to cause an electrical current to pass through the conductive coil, thereby moving the input member along a translation direction perpendicular to the input surface to produce a haptic output. The conductive coil may be fixed to an interior surface of the input member.

The electronic watch may further include a display, and a transparent cover over the display and coupled to the housing member. The processing unit may be further configured to detect a force input applied to the input member, and the haptic output may be produced in response to the detection of the force input. The input member may be configured to move in response to the force input, thereby causing the conductive coil to move within the magnetic field to induce an electrical signal in the conductive coil, and the processing unit may be configured to detect the electrical signal, and in accordance with the electrical signal satisfying a condition, initiate the haptic output.

The magnet may define an internal structure coupled to the input member, and the electronic watch may further include a compliant member defining a portion positioned between the input member and the internal structure and configured to deform in response to a force input applied to the input member. The portion of the compliant member may be a first portion, and the compliant member may further define a second portion defining a periphery of the haptic button and in contact with a surface of the hole, thereby defining a seal between the haptic button and the housing member.

The electronic watch may further include an internal structure coupled to the input member and defining a retention feature configured to receive a fastener for attaching the haptic button to the housing member.

A portable electronic device includes a housing member, a display, a transparent cover over the display and coupled to the housing member, and an input device configured to receive an input and produce a haptic output. The input device may be positioned at least partially in a hole defined through a side of the housing member and may include an internal structure including a magnet configured to generate a magnetic field. The input device may further include an input member defining an input surface of the input device, a compliant member positioned between the input member and the internal structure and configured to deform in response to the input and in response to the haptic output, and a conductive coil configured to interact with the magnetic field to move the input member relative to the internal structure to produce the haptic output. The compliant member may attach the input member to the internal structure.

The input may be a translational input, and the input member may move relative to the internal structure along a translation direction perpendicular to the input surface in response to the translational input. Moving the input member relative to the internal structure to produce the haptic output may include moving the input member along the translation direction.

The portable electronic device may be configured to detect a characteristic of the input, and in accordance with the characteristic of the input satisfying a condition, supply an electrical current to the conductive coil to produce a force on the input member to produce the haptic output. Detecting the characteristic of the input may include detecting an electrical signal induced in the conductive coil due to the conductive coil moving in the magnetic field. The characteristic of the input may be at least one of a force of the input or a translation distance of the input.

A wearable electronic device may include a housing, a touch-sensitive display coupled to the housing and configured to receive a touch input and provide a graphical output, and a crown positioned along a side of the housing and comprising a body structure, a cap structure coupled to the body structure and defining an exterior end surface of the crown, a magnet configured to generate a magnetic field, and a coil coupled to the cap structure and configured to interact with the magnetic field to impart a force on the cap structure, thereby moving the cap structure relative to the body structure to produce a haptic output.

The body structure of the crown may define at least a portion of a peripheral exterior surface of the crown. The wearable electronic device may further include a sensing system configured to detect movement of a finger along the peripheral exterior surface of the crown. The sensing system may include an optical sensing component configured to detect the movement of the finger along the peripheral exterior surface of the crown, and the optical sensing component may be mounted on the magnet.

The cap structure may be coupled to the body structure via a compliant member, and the compliant member may deform when the cap structure is moved relative to the body structure. The cap structure may be configured to move relative to the body structure in response to a force input being applied to the cap structure, thereby causing the coil to move in the magnetic field, and the wearable electronic device may be configured to detect the force input based at least in part on a change in an electrical characteristic of the coil resulting from the coil moving in the magnetic field. The haptic output may be produced in response to detecting the force input.

### BRIEF DESCRIPTION OF THE DRAWINGS

The disclosure will be readily understood by the following detailed description in conjunction with the accompanying drawings, wherein like reference numerals designate like structural elements, and in which:

FIGS. 1A-1B depict an example electronic device;

FIGS. 2A-2B depict a partial cross-sectional view of an example input device;

FIG. 3 depicts a partial exploded view of the device of FIGS. 1A-1B;

FIG. 4A depicts a partial exploded view of an example input device;

FIG. 4B depicts a partial cross-sectional view of the input device of FIG. 4A;

FIG. 5A depicts a partial cross-sectional view of an example input device for accepting rotational inputs;

FIG. 5B depicts a partial cross-sectional view of another example input device for accepting rotational inputs;

FIG. 5C depicts a partial cross-sectional view of another example input device for accepting rotational inputs;

FIG. 5D depicts a partial cross-sectional view of another example input device for accepting rotational inputs;

FIG. 6A depicts a partial view of another example electronic device having an input device for accepting rotational inputs;

FIG. 6B depicts a portion of the input device of FIG. 6A;

FIG. 6C depicts another portion of the input device of FIG. 6A;

FIG. 6D depicts an exploded view of a portion of the input device of FIG. 6A;

FIGS. 7A-7B depict additional example electronic devices with input devices; and

FIG. 8 depicts a schematic diagram of an example electronic device.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The embodiments described herein are generally directed to input devices that detect inputs and provide haptic or tactile outputs. The haptic outputs may be provided in response to detected inputs, or in response to other conditions or events at the electronic device. The input devices may be configured to accept various types of inputs, such as translational inputs (e.g., button presses), rotational inputs (e.g., rotations of a dial), or combinations of these or other types of inputs.

In some cases, haptic outputs that are produced in response to inputs being detected at an electronic device may be produced by components such as tactile dome switches, mechanical gear and/or pawl systems, or the like. Such components and systems may present challenges or drawbacks, however, as they require miniaturized mechanical parts that may be difficult to manufacture and assemble, and may wear out over time. Described herein are input devices with haptic output systems that use electromagnetic systems to produce haptic outputs. The electromagnetic systems may produce haptic outputs by moving an input member along its direction of actuation or translation. Thus, for example, when a button is pressed along an actuation axis, the electromagnetic haptic systems described herein may produce a force and/or movement of the button along the same actuation axis. The movement produced by the electromagnetic haptic systems may be a single movement or impulse, or a repetitive movement (e.g., a vibration, oscillation, or the like). The haptic output may be produced when a certain input condition is satisfied. For example, the haptic output may be produced when a button is pressed with a force that satisfies a threshold, or when the button moves more than a threshold distance. Accordingly, the haptic output may indicate to a user that an intended input has been provided to and/or detected by the device.

The haptic-enabled input systems described herein may include a movable input member with a conductive coil coupled thereto, as well as one or more magnets that generate a magnetic field. The conductive coil may be positioned so that at least a portion of the coil is in the magnetic field. Thus, when a current is passed through the coil, the interaction between the current and the magnetic field will produce a force that causes the movable input member to move, which can be detected by a user. For example, when an input is detected at the movable input member (e.g., a press of a sufficient force), the device may pass a current through the conductive coil to move the input member, thereby producing a haptic output that is detectable by the user.

In some cases, the movable input member may be movable relative to an internal structure (which may include one or more magnets that produce the magnetic field). For example, a compliant material may be positioned between the input member and the internal structure. The compliant material may allow the movable input member (and thus the conductive coil) to move relative to the internal structure in response to both force inputs and haptic outputs. In some cases, the compliant material may also form an environmental seal between the input device and the device housing. More particularly, while an input device has portions that are external to the device housing to allow direct user interaction, it also requires access via a hole or opening into the interior of the device housing (e.g., to couple to processing systems and the like). By using the same compliant material or structure to provide both a compliant coupling for the movable input member and to seal the opening in the device housing, a single component can perform multiple functions, thereby simplifying the manufacture and assembly of the input device and the electronic device as a whole.

As described herein, the conductive coil and the magnet(s) may be used to provide haptic outputs by passing a current through the conductive coil. In some cases, the conductive coil and the magnet(s) may also provide input sensing functionality. For example, an input force applied to the input member may cause the conductive coil to move within the magnetic field of the magnet(s), which in turn causes a current to be induced in the conductive coil (or another electrical characteristic of the conductive coil may change). This current, or other electrical characteristic, may be detected by the device and used as an indication that an input has been provided by a user. Accordingly, the same components that are used to provide haptic outputs to an input member may also be used to detect inputs to that input member.

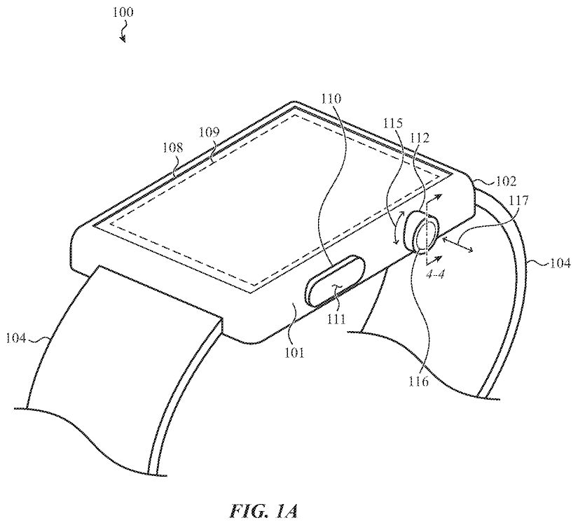

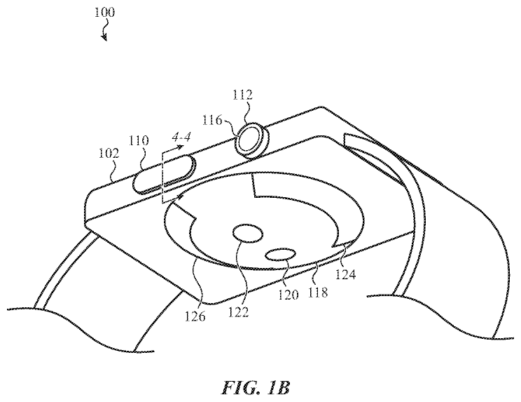

FIG. 1A depicts an electronic device 100 (also referred to herein simply as a device 100), which may use haptic-enabled input devices as described herein. The device 100 is depicted as a watch, though this is merely one example embodiment of an electronic device, and the concepts discussed herein may apply equally or by analogy to other electronic devices, including portable electronic devices such as mobile phones (e.g., smartphones), tablet computers, notebook computers, head-mounted displays, headphones, earbuds, digital media players (e.g., mp3 players), or other electronic devices.

The device 100 includes a housing 102 and a band 104 coupled to the housing. The housing 102 may at least partially define an internal volume in which components of the device 100 may be positioned. The housing 102 may also define one or more exterior surfaces of the device, such as all or a portion of one or more side surfaces, a rear surface, a front surface, and the like. The housing 102 may be formed of any suitable material, such as metal (e.g., aluminum, steel, titanium, or the like), ceramic, polymer, glass, or the like. The band 104 may be configured to attach the device 100 to a user, such as to the user's arm or wrist. The device 100 may include battery charging components within the device 100, which may receive power, charge a battery of the device 100, and/or provide direct power to operate the device 100 regardless of the battery's state of charge (e.g., bypassing the battery of the device 100). The device 100 may include a magnet, such as a permanent magnet, that is configured to magnetically couple to a magnet (e.g., a permanent magnet, electromagnet) or magnetic material (e.g., a ferromagnetic material such as iron, steel, or the like) in a charging dock (e.g., to facilitate wireless charging of the device 100).

The device 100 also includes a transparent cover 108 coupled to the housing 102. The cover 108 may define a front face of the device 100. For example, in some cases, the cover 108 defines substantially the entire front face and/or front surface of the device. The cover 108 may also define an input surface of the device 100. For example, as described herein, the device 100 may include touch and/or force sensors that detect inputs applied to the cover 108. The cover may be formed from or include glass, sapphire, a polymer, a dielectric, or any other suitable material.

The cover 108 may overlie at least part of a display 109 that is positioned at least partially within the internal volume of the housing 102. The display 109 may define an output region in which graphical outputs are displayed. Graphical outputs may include graphical user interfaces, user interface elements (e.g., buttons, sliders, etc.), text, lists, photographs, videos, or the like. The display 109 may include a liquid crystal display (LCD), an organic light emitting diode display (OLED), or any other suitable components or display technologies.

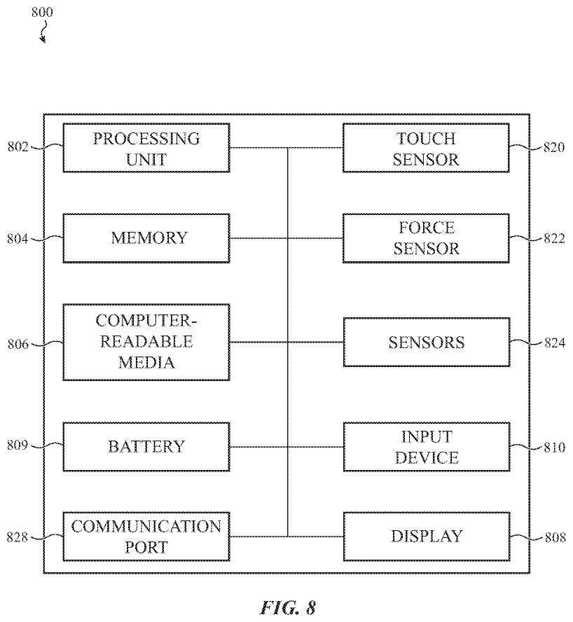

The display 109 may include or be associated with touch sensors and/or force sensors that extend along the output region of the display and which may use any suitable sensing elements and/or sensing systems and/or techniques. Using touch sensors, the device 100 may detect touch inputs applied to the cover 108, including detecting locations of touch inputs, motions of touch inputs (e.g., the speed, direction, or other parameters of a gesture applied to the cover 108), or the like. Using force sensors, the device 100 may detect amounts or magnitudes of force associated with touch events applied to the cover 108. The touch and/or force sensors may detect various types of user inputs to control or modify the operation of the device, including taps, swipes, multi-finger inputs, single- or multi-finger touch gestures, presses, and the like. Touch and/or force sensors usable with wearable electronic devices, such as the device 100, are described herein with respect to FIG. 8. A display that is associated with touch- and/or force-sensing systems to detect touch inputs applied to the cover over the display may be referred to as touch-sensitive displays.

The device 100 may include input devices, such as a button 110, a crown 112, or the like. The button 110 may control various aspects of the device 100. For example, the button 110 may be used to select icons, items, or other objects displayed on the display 109, to activate or deactivate functions (e.g., to silence an alarm or alert), or the like.

The button 110 may be a movable button or otherwise include a movable component or member. The movable member, also referred to as an input member, may define an input surface 111 that a user touches in order to provide an input to the button 110. The input member may be movable relative to the housing 102 in response to inputs and to provide haptic outputs, as described herein. For example, the input member may be coupled to a fixed structure via a compliant member (e.g., a foam, elastomer, or the like). When pressed, the compliant member may be deformed, thereby allowing the input member (and thus a conductive coil coupled to the input member) to move relative to the fixed structure to facilitate input sensing. Similarly, a force may be imparted to the input member to produce a haptic output, resulting in the compliant member deforming (e.g., changing shape in response to the force) and the input member moving against the user's finger. As described herein, both the input sensing and the haptic output may be produced using a conductive coil and one or more magnets in the button 110.

The device 100 also includes a crown 112 having a knob, external portion, or component(s) or feature(s) positioned along a side wall 101 of the housing 102. At least a portion of the crown 112 may protrude from and/or be generally external to the housing 102 and may define a generally circular shape or a circular exterior surface. The exterior surface of the crown 112 (or a portion thereof) may be textured, knurled, grooved, or may otherwise have features that may improve the tactile feel of the crown 112. In some cases, the exterior surface of the crown 112 is smooth and/or featureless, such as to provide a smooth surface against which a user's finger may slide while providing inputs to the crown 112. At least a portion of the exterior surface of the crown 112 may also be conductively coupled to biometric sensing circuitry (or circuitry of another sensor that uses a conductive path to an exterior surface), as described herein.

The crown 112 may facilitate a variety of potential user interactions, including rotational inputs (e.g., arrow 115 in FIG. 1A) and translational inputs (e.g., arrow 117 in FIG. 1A). In the case of rotational inputs, the crown 112 may include a rotationally free member that is free to rotate relative to a rotationally fixed member of the crown 112. More particularly, the rotationally free member may have no rotational constraints, and thus may be capable of being rotated indefinitely. In such cases, the device may include sensors that detect the rotation of the rotationally free member. For example, the device 100 may include an optical rotation sensor that detects the rotation of the rotationally free member.

In some cases, the crown 112 may be rotationally constrained (e.g., rotationally fixed or partially rotatable), and may include or be associated with sensors that detect when a user slides one or more fingers along a surface of the crown 112 in a movement that resembles rotating the crown 112 (e.g., a tangential movement or force that would result in rotation of a freely rotating crown). More particularly, where the crown 112 is rotationally fixed or rotationally constrained, a user input that resembles a twisting or rotating motion (e.g., imparting a tangential force on a peripheral surface of the crown 112) may not actually result in any substantial physical rotation that can be detected for the purposes of registering an input. Rather, the user's fingers (or other object) will move in a manner that resembles twisting, turning, or rotating, but does not actually continuously rotate the crown 112. Thus, in the case of a rotationally fixed or constrained crown 112, sensors may detect gestures that result from the application of an input that has the same or similar motion as (and thus may feel and look the same as or similar to) rotating a rotatable crown. As used herein, rotational inputs include inputs that result in the rotation of a rotatable component of a crown, as well as inputs that impart a tangential force to the peripheral surface of a rotationally constrained crown or otherwise result in a user's finger or other object sliding along the peripheral surface of a rotationally constrained crown.

In some cases, the sensors may include optical sensing components that are configured to detect movement of a finger along a peripheral exterior surface of the crown 112. The crown 112 may include features such as light guides, optical windows, optical emitters and/or detectors, and the like, to facilitate sensing movement of the finger along the crown surface.

The crown 112 may also be translated or pressed (e.g., axially) by the user, as indicated by arrow 117. Translational or axial inputs may select highlighted objects or icons, cause a user interface to return to a previous menu or display, or activate or deactivate functions (among other possible functions). The crown 112 may include a movable input member, such as a cap 116, that moves relative to the housing 102 in response to inputs and to provide haptic outputs, as described herein. For example, the cap 116 may be coupled to a fixed structure of the crown 112 via a compliant member (e.g., a foam, elastomer, or the like). When the crown 112 is pressed axially, the compliant member may be deformed, thereby allowing the cap 116 (and thus a conductive coil coupled to the cap) to move relative to the fixed structure to facilitate input sensing. Similarly, a force may be imparted to the cap 116 to produce a haptic output, resulting in the compliant member deforming and the cap moving against a user's finger. As described herein, both the input sensing and the haptic output may be produced using a conductive coil and one or more magnets in the crown 112.

The crown 112 may also facilitate input to biometric sensing circuitry or other sensing circuitry within the device 100. For example, the crown 112 may include a conductive surface that is conductively coupled, via one or more components of the device 100, to the biometric sensing circuitry. The conductive surface may be an exterior surface of the cap 116 that is part of the crown 112. In some cases, the cap 116, and/or the component(s) that define the conductive surface, is electrically isolated from other components of the device 100. For example, the cap 116 may be electrically isolated from the housing 102. In this way, the conductive path from the cap 116 to the biometric sensing circuitry may be isolated from other components that may otherwise reduce the effectiveness of the biometric sensor. In order to provide an input to the biometric sensor, a user may place a finger or other body part on the cap 116. The biometric sensor may be configured to take a reading or measurement in response to detecting that the user has placed a finger or other body part on the cap 116. In some cases, the biometric sensor may only take a reading or measurement when a sensing function is separately initiated by a user (e.g., by activating the function via a graphical user interface). In other cases, a reading or measurement is taken any time the user contacts the cap 116 (e.g., to provide a rotational or translational input to the crown 112). The user may have full control over when the biometric sensor takes measurements or readings and may even have the option to turn off the biometric sensing functionality entirely.

The device 100 may also include one or more haptic actuators within the housing 102. The one or more haptic actuators may be configured to produce haptic outputs that are detectable through the user's wrist, and may be in addition to the haptic systems that produce haptic outputs via the crown 112 and/or the button 110. The one or more haptic actuators may also be used to supplement the haptic outputs of the crown 112 and/or the button 110. For example, the one or more haptic actuators may produce a haptic or tactile output when the device 100 detects a rotation of the crown 112 or a gesture being applied to the crown 112. For example, a haptic actuator may produce a repetitive “click” sensation as the user rotates the crown 112 or applies a gesture to the crown 112. The one or more haptic actuators may include oscillating or rotating masses, electrostatic haptic actuators, ultrasonic actuators, and the like.

FIG. 1B shows a rear side of the device 100. The device 100 includes a rear cover 118 coupled to the housing 102 and defining at least a portion of the rear exterior surface of the device 100. The rear cover 118 may be formed of or include any suitable material(s), such as sapphire, polymer, ceramic, glass, or any other suitable material.

The rear cover 118 may define a plurality of windows to allow light to pass through the rear cover 118 to and from sensor components within the device 100. For example, the rear cover 118 may define an emitter window 120 and a receiver window 122. While only one each of the emitter and receiver windows are shown, more emitter and/or receiver windows may be included (with corresponding additional emitters and/or receivers within the device 100). The emitter and/or receiver windows 120, 122 may be defined by the material of the rear cover 118 (e.g., they may be light-transmissive portions of the material of the rear cover 118), or they may be separate components that are positioned in holes formed in the rear cover 118. The emitter and receiver windows, and associated internal sensor components, may be used to determine biometric information of a user, such as heart rate, blood oxygen concentrations, and the like, as well as information such as a distance from the device to an object. The particular arrangement of windows in the rear cover 118 shown in FIG. 1B is one example arrangement, and other window arrangements (including different numbers, sizes, shapes, and/or positions of the windows) are also contemplated. As described herein, the window arrangement may be defined by or otherwise correspond to the arrangement of components in the integrated sensor package.

The rear cover 118 may also include one or more electrodes 124, 126. The electrodes 124, 126 may facilitate input to biometric sensing circuitry or other sensing circuitry within the device 100 (optionally in conjunction with the cap 116). The electrodes 124, 126 may be a conductive surface that is conductively coupled, via one or more components of the device 100, to the biometric sensing circuitry.

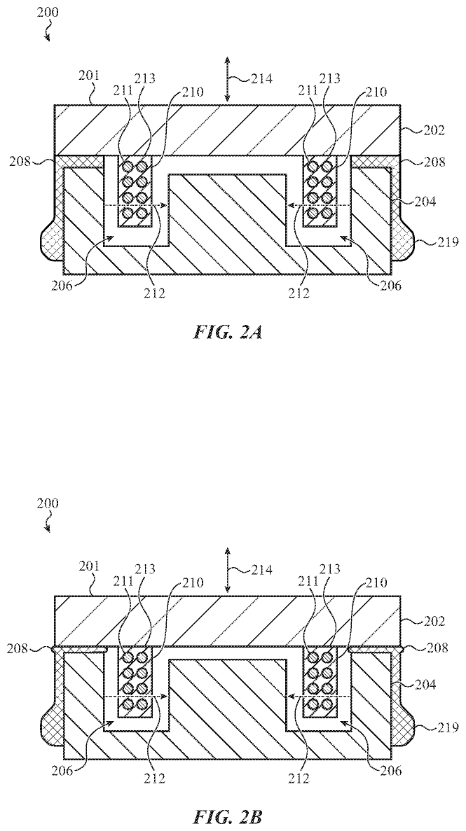

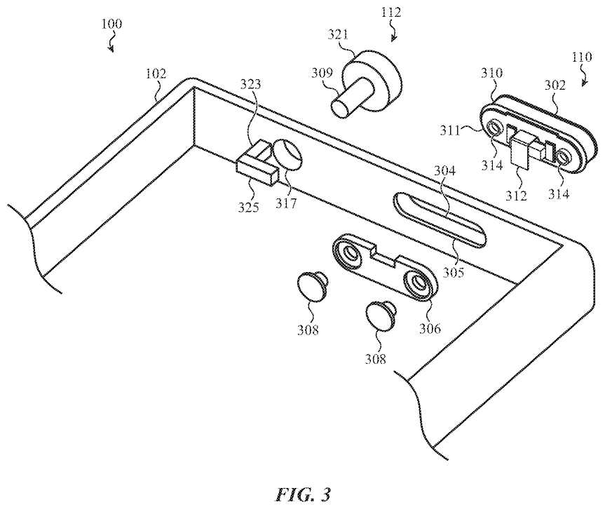

FIG. 2A depicts a partial cross-sectional view of an input device 200, which may be an example of the button 110 in FIGS. 1A-1B. As described herein, the input device 200 accepts force- and/or touch-based inputs (e.g., similar to a button) and may be configured to produce haptic outputs, and thus may be referred to as a haptic button. As used herein, input devices or systems that receive inputs and produce haptic outputs may be referred to as haptic input devices, such as haptic buttons, haptic crowns, haptic dials, and the like. The cross-sectional view in FIG. 2A corresponds to a view along line 4-4 in FIG. 1B.

The input device 200 includes an input member 202. The input member 202 defines an input surface 201 that a user may contact when providing an input to the input device 200 (e.g., when applying an input force that is substantially perpendicular to the input surface 201, such as along translation direction 214). The input member 202 may be formed from glass, sapphire, ceramic, metal, a polymer, or another suitable material. In some cases, the input device 200 may include biometric sensing functionality, such as fingerprint recognition. In such cases, the input surface 201 may define a sensing surface that the user contacts to provide a biometric input to the input device 200.

The input device 200 also includes a conductive coil 210. The conductive coil 210 may be attached to the input member 202 along a bottom or interior surface of the input member 202. The conductive coil 210 may be attached to the input member 202 via adhesives, fasteners, mechanical interlocks, or combinations of these and/or other attachment techniques. The conductive coil 210 may be rigidly attached to the input member 202, such that the conductive coil 210 moves in conjunction with the input member 202 when forces are applied to the conductive coil 210 and/or the input member 202. The conductive coil 210 may include multiple turns or loops of a conductor 211 (e.g., a wire). The conductor 211 may be at least partially encapsulated in a matrix material 213, such as an epoxy or other polymer material. Further, the conductor 211 may include an insulating coating such that adjacent portions of the conductor 211 do not conductively contact one another (e.g., so they do not produce electrical shorts between them).

The input device 200 further includes an internal structure 204. In some cases, the internal structure 204 includes one or more permanent magnets, and may generate a magnetic field in which the conductive coil 210 is at least partially positioned. In some cases, the internal structure 204 is formed substantially entirely of magnets (e.g., two or more magnets coupled together via welds, adhesive, fasteners, or the like). In some cases, the internal structure 204 includes at least one magnet, and at least one magnetically permeable material or metal. In other cases, the internal structure 204 does not include magnets, and the magnetic field is provided by one or more other magnets and/or magnetic materials that are not part of the internal structure.

The internal structure 204 may define a recess 206 into which the conductive coil 210 extends, and the magnetic field (e.g., produced by magnets that are part of and/or define the internal structure, or other magnets) may pass through the recess 206 such that at least a portion of the conductive coil 210 is within the magnetic field. Arrows 212 represent an example portion of the magnetic field (e.g., the magnetic flux) produced by the magnets of the internal structure 204. When a current is supplied to the conductive coil 210 while the conductive coil 210 is in the magnetic field, Lorentz forces may be produced and act on the conductive coil 210. These forces may be used to move the input member 202 relative to the internal structure 204 to produce a haptic output. For example, the forces may cause the input member 202 to move along a direction 214 that is perpendicular to the input surface 201 of the input member 202. The manner in which the input member 202 moves may be defined at least in part by characteristics of the current applied to the conductive coil 210. For example, the force resulting from the current (and thus the movement of the input member 202) may be defined at least in part by the direction of the current, the magnitude of the current, and the length of the conductor in the magnetic field. Further, the current may be configured to produce different types of motions, including impulses (e.g., a single impulse force), oscillations, vibrations, predefined patterns, or the like. For example, a single instance of a continuous current for a predefined duration may produce an impulse, in which the input member 202 is moved a certain distance and then returns to its rest position (along with any resulting oscillations as the input member 202 settles to its rest position). As another example, a repetitive or cyclic current (e.g., an alternating current) may produce a vibration or oscillation-type movement, in which the input member 202 moves back and forth.

In addition to producing haptic outputs, as described above, the input device 200 may detect inputs based at least in part on a measured or detected characteristic of the conductive coil 210. For example, an input force applied to the input surface 201 of the input member 202 may result in the conductive coil 210 moving within the magnetic field 212. As a result of the conductive coil 210 moving in the magnetic field 212, an electrical phenomenon (e.g., a change in voltage and/or current, or other electrical signal or characteristic) may be induced in the conductive coil 210 (e.g., in the conductor 211 of the conductive coil 210). The electrical characteristic (e.g., a voltage, amperage, impedance, resistance, or other electrical characteristic) may be detected by the device, and, if it satisfies a condition, the device may determine that an input has been provided to the input device 200. For example, if an induced voltage satisfies a condition (e.g., the voltage or other electrical characteristic satisfies a threshold value, the voltage has a particular characteristic, etc.), the input device 200 and/or associated circuitry may determine that the input member 202 has been pressed by a user. The electrical characteristic may be an instantaneous measurement or value, or it may correspond to a time-domain signal.

In some cases, the conductive coil 210 is excited or otherwise provided with an electrical signal, and whether an input is detected is based at least in part on a change in the provided electrical signal. For example, an electrical signal supplied to the conductive coil 210 may cause the input member 202 to move or oscillate (e.g., at a level that is imperceptible to a user when the user touches the input surface 201). When a user contacts the input member 202, such as to provide an input to the input device 200, the contact changes a physical characteristic of the input member 202, such as the physical dampening of the mechanical system that includes the input member 202. This change in the physical dampening (or other physical phenomena) may cause the electrical signal supplied to the conductive coil 210 to be altered in a detectable way. For example, the electrical impedance of the conductive coil 210 may change due to the physical change in the system. This change may be detected and, if the change satisfies a condition, an input may be detected.

The input device 200, and/or the electronic device that includes the input device 200, may be configured to detect inputs of varying forces. For example, if a signal or electrical characteristic of the conductive coil 210 satisfies a first condition (e.g., a first voltage or current threshold), the input may correspond to or have a first input force, and if the signal or electrical characteristic of the conductive coil 210 satisfies a second condition (e.g., a second voltage or current threshold, which may be higher than the first threshold), the input may correspond to or have a second input force (which may be higher than the first input force). In some cases, one, two, three, or more different input forces may be detected. In order to detect inputs having different force levels, the electrical characteristic or other phenomena that is detected at the conductive coil 210 may vary continuously with the input force (e.g., voltage, current, impedance, etc., may increase continuously as the input force increases).

In some cases, the input device 200 may produce different haptic outputs having multiple different haptic profiles. In particular, the signal that is provided to the conductive coil may define the haptic output, and different signals may be used to provide different haptic outputs. Different haptic outputs may be provided in response to detecting inputs of different force values, or to otherwise provide distinctive haptic outputs in response to different inputs or to indicate different device responses to an input. For example, a first haptic output having a first haptic profile (e.g., a single impulse, an impulse having a first force value, etc.) may be produced in response to an input that satisfies a first condition (e.g., a first force threshold), while a second haptic output having a second haptic profile different from the first haptic profile (e.g., multiple impulses, an impulse having a second force value greater than the first, etc.) may be produced in response to an input that satisfies a second condition (e.g., a second force threshold that is greater than the first).

In some cases, an operational state of the device or the state of the display of the device when an input is detected may control the particular haptic output that is produced. For example, if an input is provided when a list of selectable items is displayed on a display, an input to the input device 200 may cause a selectable item to be displayed, and the device may cause a first haptic output having a first haptic profile to be produced by the input device 200. If an input is provided while the device is outputting an alarm or a notification, the device may cause a second haptic output having a second haptic profile different from the first haptic profile to be produced by the input device 200. Thus, inputs having a different effect on a device may trigger haptic outputs with different haptic profiles. This may help a user differentiate between the device's response when different types of inputs are provided.

In some cases, the particular haptic outputs and haptic profiles may be user-selectable. For example, a device may allow a user to select, change, tune, define, or adjust the haptic profile(s) that are produced by the input device, and may associate those haptic profile(s) with certain input types.

The input device 200 and/or associated circuitry may be configured to distinguish electrical characteristics that are likely the result of an intentional user input from those that are likely from accidental or incidental contact, electrical interference, or the like (e.g., by evaluating the induced electrical characteristic and determining whether it satisfies a condition).

As described herein, both haptic output generation and input detection using the input device 200 rely on the input member 202 moving relative to the internal structure 204. To facilitate the movement of the input member 202 relative to the internal structure 204, the input device 200 includes a compliant member 208 positioned between the input member 202 and the internal structure 204. The compliant member 208 may be or may include a polymer such as an elastomer, foam, silicone, or the like. The compliant member 208 may be a single unitary structure, such as a monolithic polymer member, or it may be formed from or include multiple components, such as multiple layers of polymer material. The compliant member 208 may be adhered or otherwise bonded to the input member 202 and the internal structure 204. For example, the compliant member 208 may be formed of a material having adhesive properties and may form a bond directly to the surfaces of the input member 202 and the internal structure 204. As another example, the compliant material 208 includes an adhesive or is bonded to the surfaces of the input member 202 and the internal structure 204 with the adhesive (e.g., with an adhesive film, liquid adhesive, or the like).

The compliant member 208 may be configured to deform (e.g., change its shape and/or dimensions) in response to force inputs and haptic outputs. For example, when an input force is applied to the input surface 201 (e.g., when the input member 202 is pushed), the input force may cause the compliant member 208 to deform, thus allowing the input member 202 to move relative to the internal structure 204. This movement also causes the conductive coil 210 to move within the magnetic field 212, resulting in a measurable change to an electrical characteristic of the conductive coil 210 (e.g., a current or voltage or other electrical signal is induced in the coil). As noted above, this change may be used to detect the occurrence of the input. Additionally, when a haptic output is to be produced (e.g., in response to detecting an input at the input device 200), a current may be provided to the conductive coil 210, resulting in a force on the coil that moves the input member 202 and deforms the compliant member 208 (compressing, extending, or both). The properties of the compliant member 208, such as stiffness, durometer, spring constant, or the like, may be selected based on various factors, such as an amount of force that can be generated by passing a current though the conductive coil 210, a target amount of resistance to a force input, and the like.

As described herein, the compliant member 208 may also define a sealing portion 219. The sealing portion 219 may be configured to contact a surface of a hole in an electronic device housing to define an environmental seal to prevent ingress of liquid, debris, or other contaminants into the electronic device. The sealing portion 219 may be deformed or compressed by the interaction with the surface of the hole to produce intimate contact between the sealing portion 219 and the surface and define the seal. The compliant member 208 may be a single piece of material, such as a single elastomer structure that includes a portion positioned between the input member 202 and the internal structure 204, as well as the sealing portion 219.

FIG. 2A illustrates the input device 200 in a rest state or unactuated state, in which no forces (e.g., either input forces from a finger or forces from the conductive coil 210 for producing a haptic output) are acting on the input member 202. Thus, the compliant member 208 is shown in an undeformed or rest state. FIG. 2B illustrates the input device 200 with the compliant member 208 deformed or compressed. This state may result from an input force being applied to the input member 202 (e.g., a finger press) or from a haptic output being produced (e.g., a haptic output such as an oscillation or impulse may be produced by moving the input member 202 and compressing the compliant member 208). In the case of a haptic output, the deformed state of the compliant member 208 may be part of a cyclic or repetitive motion in which the input member 202 is repeatedly translated towards and away from the internal structure 204. In some cases, a haptic output may result in the compliant member 208 being stretched or expanded instead of or in addition to being compressed (e.g., the input member 202 may be forced away from the internal structure 204 during part of a haptic output, resulting in the compliant member 208 being stretched or placed in tension).

In FIGS. 2A and 2B, the compliant member 208 is shown in a distinct cross-hatching pattern, indicating that the compliant member is deformable during inputs and haptic outputs. The same or similar cross-hatching patterns are used throughout the figures to indicate compliant members. The inclusion of the distinct cross-hatching pattern in a figure does not indicate that the illustrated compliant members or materials are the only compliant members or materials in a given implementation.

While the input device 200 is described above as detecting inputs by detecting electrical characteristics of the conductive coil 210, inputs to the input device 200 may be detected in other ways. In some cases, a switch (e.g., a dome switch) may be used to detect inputs to the input device 200. For example, a dome switch or other input detection mechanism may be positioned between the internal structure 204 and the input member 202, and may be actuated when the input member 202 is pressed. Further, other types of inputs to the input device 200 may also trigger or initiate a haptic output. For example, the input device 200 may include or be associated with a touch sensitive input system that detects touch inputs on the input surface 201, and haptic outputs may be initiated in response to detecting a touch input on the input surface 201, even if that input does not result in detectable movement of the input member 202.

FIG. 3 is a partial exploded view of the device 100, illustrating the crown 112 and button 110 partially disassembled from the housing 102. As shown, the crown 112 may include a body structure 321 and a shaft 309. The shaft 309 may extend through a hole 317 formed in a side wall of the housing 102. In some cases, the body structure 321 is rotatable relative to the housing 102, while in other cases it is rotationally constrained relative to the housing 102. In cases where it is rotationally constrained, the crown 112 may include a sensing system, such as an optical sensing system, to detect gestures applied to a surface of the body structure 321 (e.g., a finger sliding along an exterior surface of the body structure 321). As described above, the crown 112 may also include a cap 116 (FIGS. 1A-1B) coupled to the body structure 321. The cap 116 may be analogous to or an embodiment of the input member 202 in FIG. 2A, and may be movable relative to the body structure 321. Further, the body structure 321 may be or may include an internal structure (e.g., analogous to the internal structure 204 in FIG. 2A). Electrical and other connections between the exterior portions of the crown (e.g., the body structure 321, a conductive coil in the body structure, etc.) and components within the device 100 may be made through the hole 317.

In some cases, the device 100 includes a rotation sensor 323 and a translation sensor 325. The rotation sensor 323 may detect rotations of the crown 112, such as by detecting the rotation of the crown shaft 309 within the device. The rotation sensor 323 may include optical sensing systems that detect light reflected from the surface of the shaft 309 (or other component of the crown 112) and determines a speed and/or direction of the rotation based on the reflected light. In some cases, the rotation sensor 323 uses self-mixing laser interferometry to determine the speed and/or direction of the rotation of the crown 112. In some cases, the rotation sensor 323 detects rotation based on other interactions with the crown (e.g., rotation of a ring coupled to the body structure 321 and external to the device 100, a finger sliding along a surface of the crown or adjacent the body structure 321, etc.). The translation sensor 325 may detect translations of the crown 112, such as a push input that translates or otherwise imparts a force to the crown 112 along an axial direction (e.g., along the length or axis of the shaft 319). The translation sensor 325 may be or may include a dome switch (which may also provide tactile feedback to the input and bias the crown 112 towards an unactuated position), a force sensor or force sensing system, an optical sensor, or any other suitable sensing system to detect a translational (or axial) input.

The button 110 may include an input member 302 (e.g., analogous to or an embodiment of the input member 202, FIG. 2A), an internal structure 311 (analogous to or an embodiment of the internal structure 204, FIG. 2A), and a compliant member 310. The compliant member 310 may define a portion that is positioned between the input member 202 and the internal structure 311 (e.g., as shown in FIG. 2A), and another portion that extends about a periphery of the button 110 and defines a seal between the button 110 and a surface of the hole 304 in the housing 102 in which the button 110 is positioned. Thus, as described herein, the compliant member 310 serves multiple functions, both providing compliance to the button 110 for detecting inputs and producing haptic outputs, and providing an environmental seal for the device.

Electrical and other connections between the exterior portions of the button 110 (e.g., the conductive coil within the button 110) and components within the device 100 may be made through the hole 304. For example, a conductive member 312 may extend from the button 110 and through the hole 304 to couple to electronic components within the device 100. The conductive member 312 may be or may include wires, a flexible circuit element, or the like.

The button 110 may be secured to the housing 102 via a bracket 306 and fasteners 308 (e.g., screws, bolts, or the like). In some cases, the internal structure 311 defines one or more retention features 314 configured to receive the fasteners. For example, the fasteners 308 may partially extend through holes in the bracket 306 and engage with the retention features 314. A portion of the housing, such as a flange or other structure, may be captured and clamped between the bracket 306 and the internal structure 311. Including the retention features 314 in the internal structure 311 allows multiple functions to be provided by a single component. In particular, the internal structure 311 provides a magnetic field for producing haptic outputs and for detecting inputs, and also serves as a structural component for mechanically coupling the button to the housing.

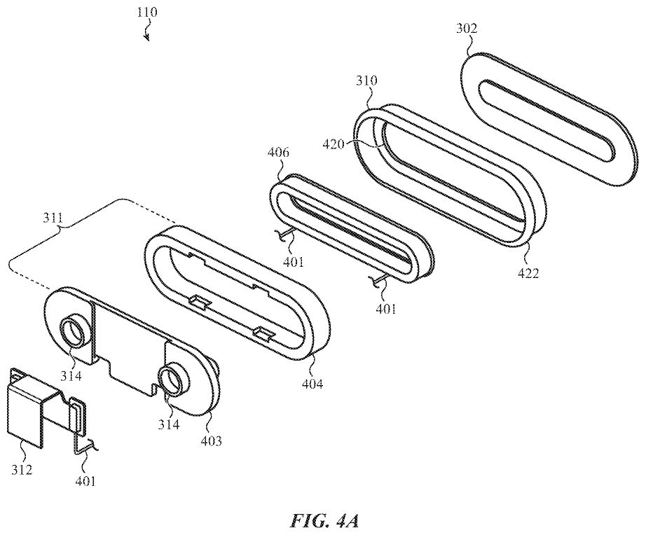

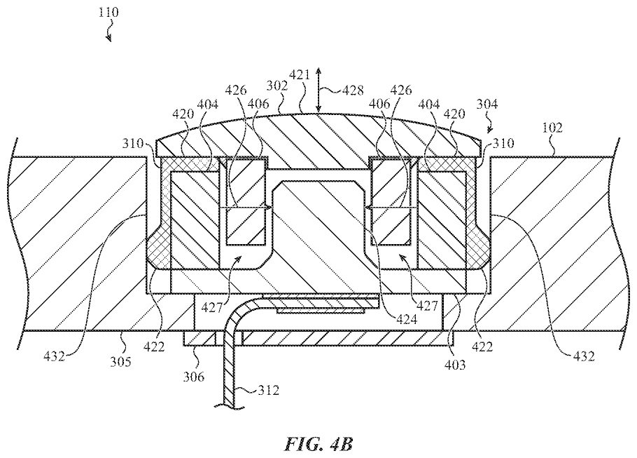

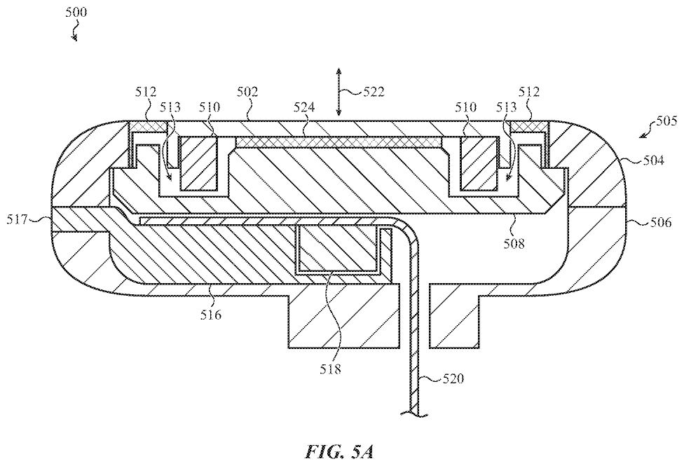

FIG. 4A is a partial exploded view of the button 110. The button 110 includes an input member 302, which may be an embodiment of the input member 202 in FIG. 2A. The input member 302 may be formed from or include glass, sapphire, ceramic, metal, polymer, or another suitable material. In some cases, the input member 302 is formed from a single monolithic component (e.g., a single piece of glass). The button 110 also includes a conductive coil 406, which may be an embodiment of the conductive coil 210 in FIG. 2A. The conductive coil 406 may be attached to the input member 302 (e.g., to a bottom or interior surface of the input member 302) via adhesive, fasteners, or the like. The conductive coil 406 may include a conductor 401 defining multiple turns of the conductive coil 406. The conductor 401 (e.g., opposite ends of the conductor defining the conductive coil 406) may be coupled to the conductive member 312, which conductively couples the conductive coil 406 to components within the device. As noted above, the conductive member 302 may be or may include a flexible circuit element (e.g., a flexible circuit board).

The internal structure 311 may include a base portion 403 and a peripheral portion 404. As noted above, the base portion 403 may include retention features 314 that receive a fastener to couple the internal structure 311 (and thus the button 110 as a whole) to the device housing.

Both the base portion 403 and the peripheral portion 404 may be permanent magnets. The base portion 403 and the peripheral portion 404 may define a recess or channel in which the conductive coil 406 is positioned (e.g., the recess 427, FIG. 4B). The base portion 403 and the peripheral portion 404 may be coupled together via welding, soldering, brazing, adhesives, mechanical interlocks, fasteners, or the like. In some cases, the base portion 403 is coupled to the peripheral portion 404 via a plurality of spot welds along an interface between the base portion 403 and the peripheral portion 404. In some cases, the base portion 403 is a permanent magnet, and the peripheral portion 404 is a magnetic permeable material. In some cases, the internal structure 311 may have more or fewer portions, components, pieces, or the like.

The base portion 403 and the peripheral portion 404 may be configured so that a magnetic field is produced in the recess in order to facilitate producing haptic outputs and detecting inputs, as described herein. The magnetic polarity of the base portion 403 and of the peripheral portion 404 may be selected to produce a particular magnetic field in the recess 427, as discussed with respect to FIG. 4B.

FIG. 4B is a partial cross-sectional view of the button 110, viewed along line 4-4 in FIG. 1B. The button 110 in FIG. 4B operates in the same or similar manner as the input device 200 described with respect to FIGS. 2A-2B. For example, the conductive coil 406, which is attached to the bottom or interior surface of the input member 302 via adhesive or the like, may be positioned at least partially in a magnetic field produced by the internal structure 311. More particularly, the internal structure 311 defines a recess 427 into which the conductive coil 406 extends. A magnetic field (represented by a single flux line 426) is produced in the recess 427 by magnets of the internal structure, such that at least a portion of the conductive coil 406 is in the magnetic field. A current may be provided to the conductive coil 406 to produce a haptic output, and a current or voltage (or other electrical signal or characteristic) may be detected in the coil 406 in response to an input force on the input member 302.

FIG. 4B also illustrates how the base portion 403 and the peripheral portion 404 cooperate to define the recess 427. For example, the base portion 403 may define a post 424 that extends upwards (as oriented in FIG. 4B) from a bottom of the base portion 403, and into a space surrounded by the peripheral portion 404. The base portion 403 and the peripheral portion 404 may cooperate to produce a magnetic field within the recess 427 (as indicated by the single flux line 426). For example, one or both of the base portion 403 or the peripheral portion 404 may be a permanent magnet configured to produce the magnetic field.

As noted above, the base portion 403 and the peripheral portion 404 may be configured so that the magnetic field in the recess 427 has a particular orientation and/or direction. For example, the direction of the magnetic flux 426 within the recess 427 may be towards the center of the internal structure 311 (e.g., towards the post 424) along the entire recess 427. In this way, a current conducted through the conductor 401 of the conductive coil 406 will result in a force acting in substantially a single direction. For example, a current passing through the conductive coil 406 in a first direction will produce a force in a first direction (e.g., upwards along the direction 428), and a current passing through the conductive coil 406 in a second direction will produce a force in a second direction opposite the first direction (e.g., downwards along the direction 428).

As shown in FIG. 4B, the input member 302 may move along a direction 428 during haptic outputs and force inputs. The direction 428 is substantially perpendicular to an input surface 421 of the input member 302. In some cases, the input member 302 is planar or defines a planar input surface. In such cases, the direction 428 is substantially perpendicular to the planar input surface. In some cases, the input member 302 and/or the input surface 421 may not be planar, such as the convex curved surface shown in FIG. 4B. In such cases, the direction 428 may be perpendicular to a tangent line or plane defined along the input surface 421. More generally, the direction 428 may correspond to a direction along which the button is pushed or actuated when implemented in a device.

FIG. 4B also illustrates how the button 110 is secured to the device housing 102. In particular, the button 110 is positioned at least partially in a hole 304 in the housing 102. The button 110 (e.g., the base portion 403 of the internal structure 311) is positioned on the flange 305, and the flange 305 is captured between the button 110 and the bracket 306. Fasteners, such as the fasteners 308 in FIG. 3, secure the bracket 306 to the button 110 and apply a retention force to the flange 305 (e.g., clamping the button 110 to the flange 305), thereby retaining the button 110 to the housing 102.

As noted above, the button 110 includes a compliant member 310, which may have multiple functions. For example, the compliant member 310 may provide compliance between the input member 302 and the internal structure 311 such that the input member 302 can move relative to the internal structure 311 during force inputs and haptic outputs, and it may also provide an environmental seal between the button 110 and the housing 102.

The compliant member 310 may define a first portion 420 that is positioned between the internal structure 311 (e.g., the peripheral portion 404) and the input member 302. The first portion 420 may be configured to deform (e.g., compress) when an input force is applied to the input member 302, and/or when the input member 302 is moved in order to produce a haptic output. More particularly, in the case of an input force, the input force compresses the first portion 420 of the compliant member 310 such that the input member 302 as well as the conductive coil 406 move relative to the internal structure 311, which results in the conductive coil 406 moving within the magnetic field. In the case of a haptic output, a signal or current is supplied to the conductive coil 406, imparting a force on the conductive coil 406 that deforms the first portion 420 of the compliant member 310 and moves the input member 302 to produce the haptic output.

The compliant member 310 also defines a second portion 422 that extends about a periphery of the button 110 and is configured to contact a surface 432 of the hole 304 in the housing. The second portion 422 may be compressed between the button 110 (e.g., between the internal structure 311) and the surface 432 to define a seal between the button 110 and the housing. The seal may inhibit ingress of water, liquids, or other contaminants into the housing. In some cases, the seal conforms to an ingress protection standard, such as IP65, IP66, IP67, or IP68.

The use of the compliant member 310 between the input member 302 and the internal structure 311 may also help improve the sealing functionality of the button 110. In particular, the configuration of the button 110 with the compliant member 310 allows the input member 302 to move without requiring the seal to slide or move along a sealing surface. Rather, the input member 302 is allowed to move (e.g., for sensing force inputs and producing haptic outputs), while the second portion 422 can remain in static contact with the surface 432 of the hole 304. Positioning the portion that provides button compliance outside of the environmental seal (e.g., exterior to the interface between the second portion 422 and the surface 432) ensures sealing performance while allowing button compliance, and may also reduce the overall component count and complexity of the button and the device as a whole.

As noted herein, the compliant member 310 may be a unitary component or material (e.g., a single piece of a polymer such as a silicone, elastomer, or the like) that performs multiple different functions. For example, a single piece of material may provide both the compliance for the input member to facilitate both force inputs and haptic outputs, and the sealing function to environmentally seal the gap between the button 110 and the housing. The compliant member 310 may be attached to the internal structure 311 and the input member 302, such as via an adhesive bond. For example, the compliant member 310 may be formed by molding the compliant member 310, and then adhering it to the internal structure 311 and the input member 302. In such cases, an adhesive such as an adhesive film, a liquid adhesive, or the like, may be used to adhere the compliant member 310 to the internal structure 311 and the input member 302. As another example, the compliant member 310 may be formed by molding the compliant member 310 to the internal structure 311 such that the material of the compliant member 310 bonds directly to the internal structure 311. For example, the internal structure 311 may be positioned in a mold cavity, and the material for the compliant member 310 may be introduced (e.g., injected) into the mold cavity and onto the side and top surfaces of the internal structure 311. The material may conform to the shape of the mold cavity to form the compliant member 310 and bond directly to the internal structure 311 during the molding and/or subsequent curing and/or hardening process. The input member 302 may be adhered to the compliant member 310 (e.g., via a separate adhesive), or it may be applied to the material of the compliant member 310 such that it forms a bond directly to the compliant member 310.

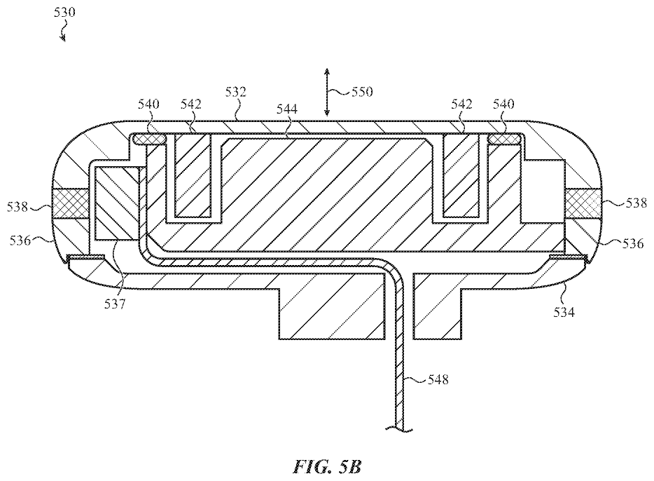

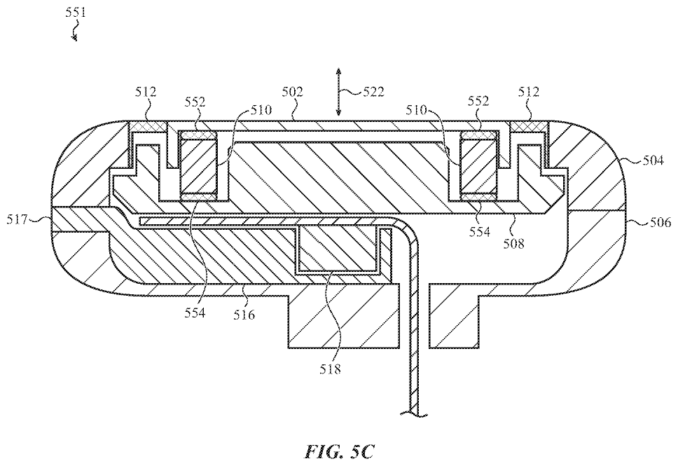

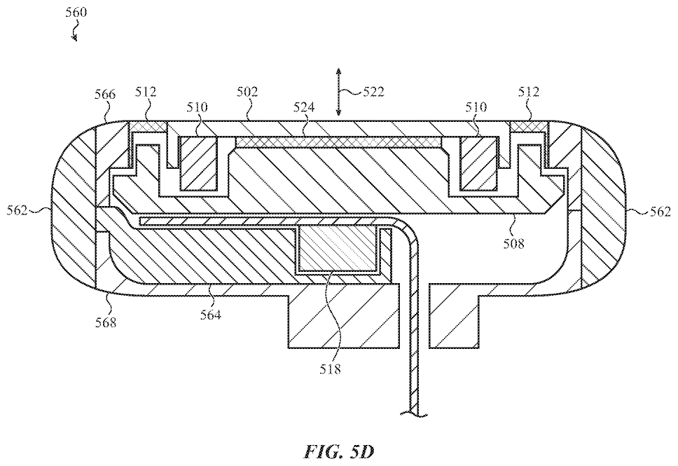

As described herein, magnet assemblies and conductive coils may be used with other types of input devices to provide input sensing as well as haptic outputs. For example, FIGS. 5A-7 illustrate examples of crowns that include a movable input member along with a conductive coil and an internal structure to facilitate sensing translational inputs and producing haptic outputs.

FIG. 5A illustrates an example crown 500, which may correspond to or be an embodiment of the crown 112, FIGS. 1A-1B. The crown 500 includes a cap structure 502 (which may be analogous to the input members 202, 302 described above), a conductive coil 510 coupled to the cap structure 502, and an internal structure 508. As described herein, the internal structure may include or be formed from magnets that produce a magnetic field in which the conductive coil 510 is positioned. The cap structure 502 defines an exterior end surface of the crown 500 that a user may touch or press in order to provide a translational or axial input to the crown 500.

The crown 500 also includes a body structure 505 to which the cap structure 502 is coupled. The body structure 505 may include a base portion 506 and a ring portion 504. In other examples, the body structure 505 may be a monolithic component.

The crown 500 may include systems and components for sensing movement of a finger along a peripheral exterior surface of the crown 500. For example, the crown 500 may define an optical window 517 along the peripheral exterior surface of the crown 500. The optical window 517 may be defined by or optically communicate with an optical guide 516. The optical guide 516 may transmit or guide light (e.g., laser beams, images, etc.) to and/or from an optical sensing component 518.

The optical sensing component 518 may be or be part of an optical sensing system that detects, via the optical window 517, movement of the finger along the peripheral surface of the crown. In some cases, the optical sensing component 518 is or includes a laser module that emits a laser beam, through the optical guide 516 and the optical window 517, onto a user's skin, and receives a reflected portion of the laser beam via the optical guide 516. In such cases, the optical sensing system may use self-mixing laser interferometry to determine characteristics of the inputs, such as the speed and/or direction of the user's finger along the peripheral surface of the crown. For example, interference (or other interaction) between a laser beam that is directed onto the user's finger and the laser light that is reflected from the user's finger back into the laser source may be used to determine the characteristics. As described above, the movement of a user's finger across a non-rotating portion of a crown may resemble a rotational input to the crown, and the characteristics of the inputs may control a device in a manner similar to a rotational input.

The optical component 518 may be coupled to other circuitry within a device. For example, the optical component 518 may be attached to a circuit element 520, such as a flexible circuit board, which may conductively couple the optical component 518 to a processor or other component or circuitry within a device.

The cap structure 502 is movable relative to the body structure 505 and to the internal structure 508 (which may be coupled to the body structure 505). For example, the cap structure 502 may be coupled to the body structure 505 via compliant members 512, 524. The compliant member 512 may extend between the ring portion 504 and a periphery of the cap structure 502. The compliant member 512 may define part of the axial end surface of the crown 500, along with the cap structure 502 and a portion of the ring portion 504. The compliant member 512 may be adhered or otherwise bonded to the ring portion 504 and the cap structure 502. The compliant member 512 may be formed from a polymer, such as a silicone, elastomer, or the like, and may deflect and/or deform to allow the cap structure 502 to move relative to the body structure 505, such as in response to a force input applied to the cap structure 502 and a haptic output produced by an interaction between the conductive coil 510 and the magnetic field in the recess 513 of the internal structure 508. The compliant member 512 may also form an environmental seal between the cap structure 502 and the ring portion 504 to inhibit ingress of water, dust, and/or other liquids and contaminants.

The compliant member 524 may be positioned between an interior surface of the cap structure 502 and a surface of the internal structure 508. The compliant member 524 may be formed from a polymer, such as a silicone, elastomer, or the like, and may deform to allow the cap structure 502 to move relative to the body structure 505, such as in response to a force input applied to the cap structure 502 and a haptic output produced by an interaction between the conductive coil 510 and the magnetic field of the internal structure 508. The compliant member 524 may also bias the cap structure 502 towards a neutral or rest position, at which the cap structure 502 is positioned when it is not being pressed (from an input) or moved (for a haptic output).

The compliant members 512, 524 may be formed and/or assembled in a manner similar to the compliant member 310. For example, one or both of the compliant members 512, 524 may be formed (e.g., molded) separately from the other crown components, and then attached (e.g., via adhesive or other attachment technique) to the crown components. As another example, one or both of the compliant members 512, 524 may be formed via insert molding in which crown components are placed into a mold cavity, and then a polymer material is injected into the mold cavity and against the crown components, thereby forming the compliant member(s) and attaching them to the crown components.

The conductive coil 510 and the internal structure 508 operate in substantially the same manner as those described above with respect to FIGS. 2-4B. For example, a current or signal may be supplied to the conductive coil 510 to impart a force onto the cap structure 502 to cause the cap structure 502 to move to produce a haptic output. The haptic output may be produced in response to an input being detected at the crown 500. For example, in response to detecting a force input applied to the cap structure 502 (e.g., an axial force along the translation direction 522), a haptic output may be produced by moving the cap structure 502 against the user's finger (or other implement that supplied the force input). In some cases, the haptic output may be produced during a rotational input (either rotating a rotatable component or sliding a finger along a crown surface, as described above). For example, the haptic output may be produced to produce a clicking or other repetitive tactile sensation to indicate to a user that the rotational inputs have been detected. In such cases, the movement of the cap structure 502 may produce a tactile output that is perceptible along the peripheral surface of the crown 500, even though the user's finger may not be in direct contact with the cap structure 502.

FIG. 5B illustrates another example crown 530, which may correspond to or be an embodiment of the crown 112, FIGS. 1A-1B. The crown 530 may include a cap structure 532 (which may be analogous to the input members 202, 302 described above), a conductive coil 542 coupled to the cap structure 532, and an internal structure 544. As described herein, the internal structure may include or be formed from magnets that produce a magnetic field in which the conductive coil 542 is positioned). The cap structure 532 defines an exterior end surface of the crown 530 that a user may touch or press in order to provide a translational or axial input to the crown 530. The cap structure 532 may also define part of a peripheral surface of the crown 530, which a user contacts to provide rotational inputs to the crown 530.

The cap structure 532 may be coupled to a base portion 536 via a compliant member 538. In some cases, the base portion 536 is coupled to an additional base portion 534 (e.g., via adhesive, welding, soldering, brazing, fasteners, interlocking structures, etc.). The additional base portion 534 may be coupled to a device housing and may define a shaft or other structure that couples the crown 530 to the device. In other cases, the base portion 536 and the additional base portion 534 are instead formed as a monolithic component.

The compliant member 538 may extend around an entire periphery of the crown 530 and may provide the compliance necessary for the cap structure 532 to move relative to the base portion 536. The compliant member 538 may be adhered or otherwise bonded to the cap structure 532 and the base portion 536. The compliant member 538 may be formed from a polymer, such as a silicone, elastomer, or the like, and may deform to allow the cap structure 532 to move relative to the base portion 536, such as in response to a force input applied to the cap structure 532 and a haptic output produced by an interaction between the conductive coil 542 and the magnetic field of the internal structure 544. The compliant member 538 may also form an environmental seal between the cap structure 532 and the base portion 536 to inhibit ingress of water, dust, and/or other liquids and contaminants.

The compliant member 538 may also define an optical window along the peripheral exterior surface of the crown 530. More particularly, all or part of the compliant member 538 may be light transmissive to allow optical sensing of a finger or other object in contact with the peripheral surface of the crown 530. For example, the crown 530 may include an optical sensing component 537 that is or is part of an optical sensing system that detects, via an optically transmissive part of the compliant member 538, movement of a finger along the peripheral surface of the crown 530. In some cases, the optical sensing component 537 is or includes a laser module that emits a laser beam, through the compliant member 538 onto a user's skin, and receives a reflected portion of the laser beam through the compliant member 538. In such cases, the optical sensing system may use self-mixing laser interferometry to determine characteristics of the inputs, such as the speed and/or direction of the user's finger along the peripheral surface of the crown, as described herein. The optical component 537 may be coupled to other circuitry within a device. For example, the optical component 537 may be attached to a circuit element 548, such as a flexible circuit board, which may conductively couple the optical component 537 to a processor or other component or circuitry within a device.

The cap structure 532 is movable relative to the base portion 536 and to the internal structure 544 (which may be coupled to the base portion 536). For example, the cap structure 532 may be coupled to the base portion 536 via the compliant member 538. The compliant member 538 may be formed from a polymer, such as a silicone, elastomer, or the like, and may deform to allow the cap structure 532 to move relative to the base portion 536, such as in response to a force input applied to the cap structure 532 and a haptic output produced by an interaction between the conductive coil 542 and the magnetic field of the internal structure 544. The compliant member 538 may also form an environmental seal between the cap structure 532 and the base portion 536 to inhibit ingress of water, dust, and/or other liquids and contaminants.

The crown 530 may also include a compliant member 540 positioned between an interior surface of the cap structure 532 and a surface of the internal structure 544. The compliant member 540 may be formed from a polymer, such as a silicone, elastomer, or the like, and may deform to allow the cap structure 532 to move relative to the base portion 536, such as in response to a force input applied to the cap structure 532 and a haptic output produced by an interaction between the conductive coil 542 and the magnetic field of the internal structure 544. The compliant member 540 may also bias the cap structure 532 towards a neutral or rest position, at which the cap structure 532 is positioned when it is not being pressed (from an input) or moved (for a haptic output). The compliant member 540 may be attached to one or both of the cap structure 532 and the internal structure 544 (e.g., via adhesive or another suitable bonding technique). In some cases, the compliant member 540 is omitted from the crown 530, and the compliance and biasing functions are provided solely by the compliant member 538.

The compliant members 538, 540 may be formed and/or assembled in a manner similar to the compliant member 310. For example, one or both of the compliant members 538, 540 may be formed (e.g., molded) separately from the other crown components, and then attached (e.g., via adhesive or other attachment technique) to the crown components. As another example, one or both of the compliant members 538, 540 may be formed via insert molding in which crown components are placed into a mold cavity, and then a polymer material is injected into the mold cavity and against the crown components, thereby forming the compliant member(s) and attaching them to the crown components.

The conductive coil 542 and the internal structure 544 operate in substantially the same manner as those described above with respect to FIGS. 2-4B. For example, a current or signal may be supplied to the conductive coil 542 to impart a force onto the cap structure 532 to cause the cap structure 532 to move to produce a haptic output. The haptic output may be produced in response to an input being detected at the crown 530. For example, in response to detecting a force input applied to the cap structure 532 (e.g., an axial force along the direction 550), a haptic output may be produced by moving the cap structure 532 against the user's finger (or other implement that supplied the force input). In some cases, the haptic output may be produced during a rotational input (either rotating a rotatable component or sliding a finger along a crown surface, as described above). For example, the haptic output may be produced to produce a clicking or other repetitive tactile sensation to indicate to a user that the rotational inputs have been detected. In such cases, the movement of the cap structure 532 may produce a tactile output that is perceptible along the peripheral surface of the crown 530. For example, the movement of the cap structure 532 may cause the compliant member 538 to deform in a tactilely perceptible way (e.g., temporarily forming a convex or concave shape on the peripheral surface of the crown). Additionally, the movement of the cap structure 532 may impart a shearing force or interaction on the user's skin, which may also be perceptible as a click or other haptic or tactile sensation.

FIG. 5C illustrates another example crown 551. The crown 551 may be the same as the crown 500, except as described below. For ease of reference, components that are structurally and/or functionally the same in the crown 500 and the crown 551 share the same element numbers.

In the crown 500 in FIG. 5A, the conductive coil 510 is rigidly coupled to the cap structure 502. In the crown 551 in FIG. 5C, the conductive coil 510 may be suspended between an upper compliant member 552 and a lower compliant member 554. The operation of the conductive coil 510 and the internal structure 508 for sensing inputs and producing haptic outputs may operate in the same or similar manner as described above. For example, in order to produce a haptic output, a current may be provided to the conductive coil 510, which causes the conductive coil 510 to experience a force that acts either upwards or downwards (e.g., along the axis indicated by arrow 522). This force causes the conductive coil 510 to move, thereby compressing one or the other of the upper or lower compliant members 552, 554 and causing the cap structure 502 to move as well. The upper and lower compliant members 552, 554 may be in a partially compressed state when the crown 551 is in a neutral state (e.g., not producing a haptic output or receiving a translational input). Accordingly, a force that moves the conductive coil 510 in one direction (e.g., upwards) may cause one compliant member to compress and the other to expand. Additionally, an input force applied to the cap structure 502 causes the upper and lower compliant members 552, 554 to deform and results in motion of the conductive coil 510 that can be detected based on electrical changes in the conductive coil 510.

In the example crowns described herein, compliant members and compliant materials are used to facilitate motion between certain components so that haptic outputs can be produced and inputs can be sensed. Properties of the compliant members and/or their materials, including but not limited to shape, size, stiffness, durometer, and spring constant may be selected to produce desired physical performance. For example the properties may be tuned to provide a target translational travel distance, a target force-versus-translational distance response, a target resonant frequency, and the like.

FIG. 5D illustrates another example crown 560. The crown 560 may be the same as the crown 500, except as described below. For ease of reference, components that are structurally and or functionally the same in the crown 500 and the crown 560 share the same element numbers.

Whereas the crown 500 may be configured to detect movement (e.g., sliding) of a finger along its optical window via the optical guide, the crown 560 may be configured to detect the rotation of a rotationally free peripheral structure 562. More particularly, the peripheral structure 562 may be configured to rotate relative to a ring portion 566 and base portion 568. The peripheral structure 562 may be rotationally coupled to the ring portion 566 and/or base portion 568 via bearings, bushings, or the like.

The optical sensing component 518 may determine the speed and/or direction of the rotational movement of the peripheral structure 562 based on optical signals sent and/or received through the optical guide 564. The optical sensing component 518 may use the same or similar techniques for sensing the rotational movement of the peripheral structure 562, including self-mixing laser interferometry, as described herein.

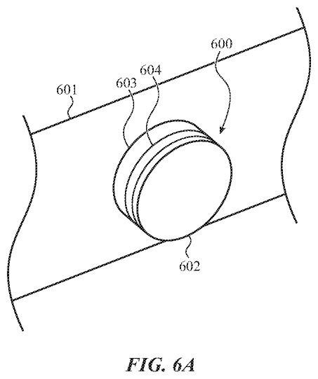

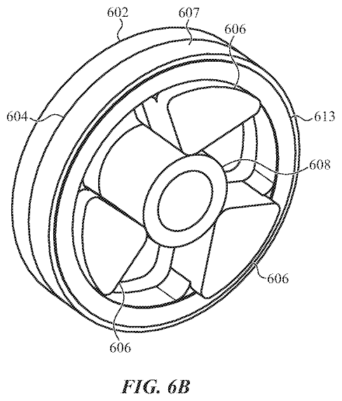

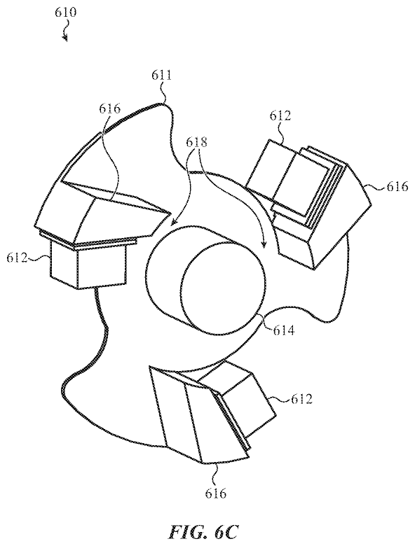

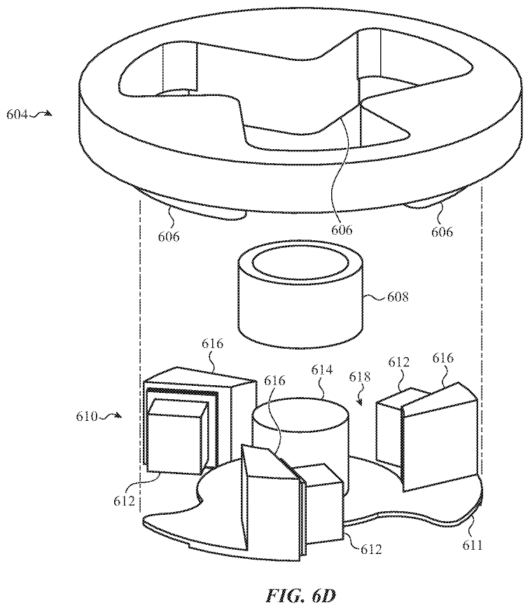

FIGS. 6A-6D illustrate another example crown 600 that uses optical sensing to detect rotational inputs along the surface of the crown, as well as a conductive coil to produce haptic outputs and facilitate input sensing. The crown 600 may be positioned along a side surface of a housing 601. In some cases, a base 603 of the crown 600 may be a protrusion or other feature of the housing 601 (e.g., the base 603 may be machined or otherwise formed from the same piece of material as the housing 601).

The crown 600 further includes an optically transmissive structure 604 extending at least partially around the periphery of the crown 600 (as shown, the optically transmissive structure 604 extends around an entire periphery of the crown 600). The optically transmissive structure 604 may facilitate sensing of rotational inputs along the periphery of the crown 600. For example, an optical sensing system within the crown 600 may detect characteristics of a finger sliding along the surface of the optically transmissive structure 604. The crown 600 may also include a cap structure 602. The cap structure 602 may be rotationally constrained, but may accept translational or axial inputs.

FIG. 6B illustrates a partial view of the cap structure 602 and optically transmissive structure 604, shown removed from the housing 601, showing details of the internal arrangement of the crown 600. As shown in FIG. 6B, the crown 600 includes a conductive coil 608, which is coupled to the cap structure 602. The conductive coil 608 operates in the same or similar manner to other conductive coils described herein to facilitate sensing inputs and producing haptic outputs. The crown 600 may also include a compliant member 613 positioned between the optically transmissive structure 604 and the base 603 (as shown) or positioned between the cap structure 602 and the optically transmissive structure 604. The compliant member 613 may allow the cap structure 602 (and thus the conductive coil 608) to move relative to the internal structure 611 (FIG. 6C) to facilitate input sensing and haptic outputs, as described herein.

The optically transmissive structure 604 defines a peripheral window portion 607 and optical guides 606. The optical guides 606 may guide light to and/or from optical sensing components 612 (FIG. 6C) in the crown. The optically transmissive structure 604 may be of unitary construction. For example, the peripheral window portion 607 and the optical guides 606 may be formed from a single monolithic piece of light-transmissive material (e.g., glass, plastic, or the like).

FIG. 6C illustrates a carrier structure 610 of the crown 600. The carrier structure 610 includes an internal structure 611. The internal structure 611 defines a plurality of outer posts 616 and a central post 614. In some cases, the outer posts 616 and the central post 614 are permanent magnets. In some cases, magnets are coupled to the outer posts 616 and the central post 614 or otherwise coupled to the internal structure 611. The posts 616, 614 together define a channel 618 in which the conductive coil 608 is positioned when the crown 600 is assembled. For example, the post 614 may extend into the central hole defined by the conductive coil 608, and the conductive coil 608 is positioned in the channel 618 between the posts 616, 614. The internal structure 611 produces a magnetic field that extends across the channel, as described herein, such that the conductive coil 608 is at least partially within the magnetic field when the crown 600 is assembled and the conductive coil 608 is within the channel 618.

The carrier structure 610 also serves as a structural mounting point for optical sensing components 612. For example, the optical sensing components 612 may be mounted to side surfaces of the outer posts 616 which, when the crown 600 is assembled, results in the optical sensing components 612 positioned proximate the optical guides 606 such that the optical sensing components 612 can optically communicate with the optical guides 606. For example, the optical sensing components 612 may emit light (e.g., a laser beam) into the optical guides 606, and receive reflected light back through the optical guides 606. In such cases, the light propagates through the optical guides 606 and the peripheral window portion 607, reflects off an object on or proximate the peripheral window portion 607, and propagates back through the peripheral window portion 607 and through the optical guides 606 to the optical sensing components 612. The optical sensing components 612 may detect characteristics of the rotational input (e.g., a speed and/or direction) based on the reflected light. In some cases, the optical sensing components 612 include a laser module that uses self-mixing laser interferometry to determine characteristics of the inputs on the peripheral window portion 607.

FIG. 6D is an exploded view of a portion of the crown 600, illustrating how the carrier structure 610 is positioned relative to the optically transmissive structure 604. In particular, the outer posts 616 of the internal structure 611 extend into spaces between the optical guides 606, and the central post 614 extends into the center of the conductive coil 608. This assembly configuration positions the optical sensing components 612 proximate an optical surface of the optical guides 606 and also positions the conductive coil 608 in the channel 618 between the outer posts 616 and the central post 614, such that the magnet is in the magnetic field of the internal structure 611 to facilitate sensing inputs and producing haptic outputs, as described herein.

In the example crowns described herein, compliant members and compliant materials are used to facilitate motion between certain components so that haptic outputs can be produced and inputs can be sensed. Properties of the compliant members and/or their materials, including but not limited to shape, size, stiffness, durometer, and spring constant may be selected to produce desired physical performance. For example the properties may be tuned to provide a target translational travel distance, a target force-versus-translational distance response, a target resonant frequency, and the like.

As described herein, rotational inputs may be sensed using an optical sensing system that uses light reflected by a moving object (e.g., either a finger or other implement, or a rotating structure of a crown such as the peripheral structure 562) to determine the speed and/or direction of the rotational inputs. For example, light may be directed onto the moving object, and at least a portion of that light may be reflected by the moving object and detected by the sensing system. The sensing system may use the reflected light to determine characteristics of the rotational inputs. In some cases, the sensing system may use self-mixing laser interferometry to determine characteristics of the rotational inputs. In such cases, interference (or other interaction) between a laser beam that is directed onto a moving object and the laser light that is reflected from the moving object back into the laser source may be used to determine the characteristics. For example, the motion of the moving object may affect the frequency of the reflected light. For example, if the moving object is moving in one direction (e.g., a first rotational direction), the frequency of the reflected light may be higher than that of the incident light, and if the moving object is moving in the opposite direction (e.g., a second rotational direction), the frequency of the reflected light may be lower than that of the incident light. Moreover, a greater speed produces a greater shift in frequency of the reflected light. Thus, a higher speed will result in a larger frequency shift of the reflected light, as compared to a lower speed. The difference in the frequency of the emitted light and the reflected light may have an effect on a laser emitter (e.g., the optical sensing component 518, 537, 612) that can be used to detect the speed and/or direction of the movement. For example, when reflected light is received by the laser emitter (while the laser emitter is also emitting light), the reflected light may cause a change in a frequency, amplitude, and/or other property(s) of the light being produced by the laser. These changes may be detected by the laser (and/or associated components and circuitry) and used to generate a signal that corresponds to the movement. The signal may then be used to control functions of the device, such as to modify graphical outputs being displayed on the device.

Other types of optical sensing systems may be used instead of or in addition to self-mixing laser interferometry. For example, an image sensor may be used to detect characteristics of the inputs by analyzing images of the moving object.

Optical sensing systems as described herein may use light having different spectral content. In some cases, the optical sensing system uses visible light, while in other cases they use non-visible light (e.g., infrared light). Optically transmissive components and/or materials may be selected in any given implementation to transmit light having the relevant spectral content for that implementation. Accordingly, in some cases, an optically transmissive component and/or material may be optically transmissive to some light (e.g., non-visible light such as infrared light) and not transmissive to other light (e.g., visible light). Thus, in some cases, an optically transmissive component may appear to an unaided eye as being opaque, though it may still be optically transmissive or light-transmissive for the spectra relevant to the optical sensing system.

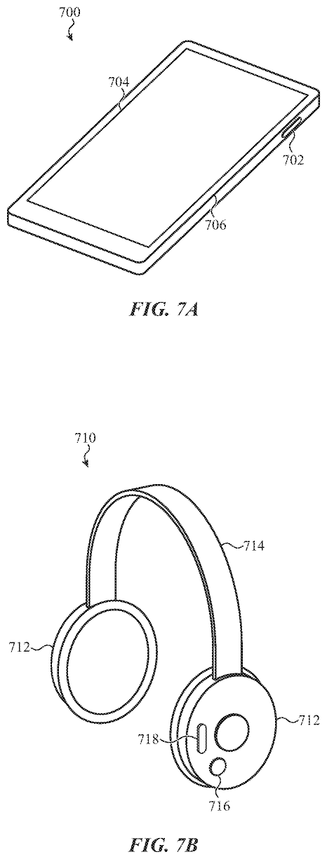

The input devices described herein may be incorporated in various types of electronic devices. For example, FIGS. 1A-1B illustrate input devices (e.g., a haptic buttons and a haptic crown) incorporated in an electronic watch. This is merely one example of an electronic device that may use the input devices as described herein. FIGS. 7A-7B illustrate additional examples of electronic devices that may use the input devices. For example, FIG. 7A illustrates a portable electronic device 700 that includes a housing 706, a display 704, and an input device 702. The input device 702 may correspond to or be an embodiment of the input devices 110, 200 described herein, and may have the same or analogous structures and functions as the input devices 110, 200, or other input devices described herein. The portable electronic device 700 represent a mobile phone, tablet computer, music player, a portion of a laptop or notebook computer, or other portable electronic device.

FIG. 7B illustrates an example headset 710 (e.g., headphones or earphones) that may include input devices as described herein. The headset 710 may include speaker bodies 712 that are configured to rest on and/or around a user's ear, and a support structure 714 that couples the speaker bodies 712 and facilitates mounting the headset 710 to a user's head. One or both of the speaker bodies 712 may include input devices as described herein, such as a first input device 718, which may correspond to or be an embodiment of the input devices 110, 200 described herein, and may have the same or analogous structures and functions as the input devices 110, 200, and a second input device 716, which may correspond to or be an embodiment of the input devices 112, 500, 530, 551, 560, 600 described herein, and may have the same or analogous structures and functions as those input devices. While FIG. 7B illustrates a pair of headphones or earphones, it may represent other wearable devices, head-mounted devices, and the like.

FIG. 8 depicts an example schematic diagram of an electronic device 800. By way of example, the device 800 of FIG. 8 may correspond to the wearable electronic device 100 shown in FIGS. 1A-1B (or any other wearable electronic device described herein). To the extent that multiple functionalities, operations, and structures are disclosed as being part of, incorporated into, or performed by the device 800, it should be understood that various embodiments may omit any or all such described functionalities, operations, and structures. Thus, different embodiments of the device 800 may have some, none, or all of the various capabilities, apparatuses, physical features, modes, and operating parameters discussed herein.

As shown in FIG. 8, a device 800 includes a processing unit 802 operatively connected to computer memory 804 and/or computer-readable media 806. The processing unit 802 may be operatively connected to the memory 804 and computer-readable media 806 components via an electronic bus or bridge. The processing unit 802 may include one or more computer processors or microcontrollers that are configured to perform operations in response to computer-readable instructions. The processing unit 802 may include the central processing unit (CPU) of the device. Additionally or alternatively, the processing unit 802 may include other processors within the device including application specific integrated chips (ASIC) and other microcontroller devices.

The memory 804 may include a variety of types of non-transitory computer-readable storage media, including, for example, read access memory (RAM), read-only memory (ROM), erasable programmable memory (e.g., EPROM and EEPROM), or flash memory. The memory 804 is configured to store computer-readable instructions, sensor values, and other persistent software elements. Computer-readable media 806 also includes a variety of types of non-transitory computer-readable storage media including, for example, a hard-drive storage device, a solid-state storage device, a portable magnetic storage device, or other similar device. The computer-readable media 806 may also be configured to store computer-readable instructions, sensor values, and other persistent software elements.

In this example, the processing unit 802 is operable to read computer-readable instructions stored on the memory 804 and/or computer-readable media 806. The computer-readable instructions may adapt the processing unit 802 to perform the operations or functions described herein. In particular, the processing unit 802, the memory 804, and/or the computer-readable media 806 may be configured to cooperate with a sensor 824 (e.g., a rotation sensor that senses rotation of a crown component) to control the operation of a device in response to an input applied to a crown of a device (e.g., the crown 112). The computer-readable instructions may be provided as a computer-program product, software application, or the like.

As shown in FIG. 8, the device 800 also includes a display 808. The display 808 may include a liquid-crystal display (LCD), organic light emitting diode (OLED) display, light emitting diode (LED) display, or the like. If the display 808 is an LCD, the display 808 may also include a backlight component that can be controlled to provide variable levels of display brightness. If the display 808 is an OLED or LED type display, the brightness of the display 808 may be controlled by modifying the electrical signals that are provided to display elements. The display 808 may correspond to any of the displays shown or described herein.

The device 800 may also include a battery 809 that is configured to provide electrical power to the components of the device 800. The battery 809 may include one or more power storage cells that are linked together to provide an internal supply of electrical power. The battery 809 may be operatively coupled to power management circuitry that is configured to provide appropriate voltage and power levels for individual components or groups of components within the device 800. The battery 809, via power management circuitry, may be configured to receive power from an external source, such as an AC power outlet. The battery 809 may store received power so that the device 800 may operate without connection to an external power source for an extended period of time, which may range from several hours to several days.

In some embodiments, the device 800 includes one or more input devices 810. An input device 810 is a device that is configured to receive user input. The one or more input devices 810 may include, for example, a crown input system, a push button, a touch-activated button, a keyboard, a keypad, or the like (including any combination of these or other components). In some embodiments, the input device 810 may provide a dedicated or primary function, including, for example, a power button, volume buttons, home buttons, scroll wheels, and camera buttons.

The device 800 may also include a sensor 824. The sensor 824 may detect inputs provided by a user to a crown of the device (e.g., the crown 112). The sensor 824 may include sensing circuitry and other sensing components that facilitate sensing of rotational motion of a crown, as well as sensing circuitry and other sensing components (optionally including a switch) that facilitate sensing of axial motion of the crown. The sensor 824 may include components such as an optical sensing unit (e.g., the optical sensing components 518, 537, 612), a tactile or dome switch, or any other suitable components or sensors that may be used to provide the sensing functions described herein. The sensor 824 may also be a biometric sensor, such as a heart rate sensor, electrocardiograph sensor, temperature sensor, or any other sensor that conductively couples to the user and/or to the external environment through a crown input system, as described herein. In cases where the sensor 824 is a biometric sensor, it may include biometric sensing circuitry, as well as portions of a crown that conductively couple a user's body to the biometric sensing circuitry. Biometric sensing circuitry may include components such as processors, capacitors, inductors, transistors, analog-to-digital converters, or the like.

The device 800 may also include a touch sensor 820 that is configured to determine a location of a touch on a touch-sensitive surface of the device 800 (e.g., an input surface defined by the portion of a cover 108 over a display 109). The touch sensor 820 may use or include capacitive sensors, resistive sensors, surface acoustic wave sensors, piezoelectric sensors, strain gauges, or the like. In some cases, the touch sensor 820 associated with a touch-sensitive surface of the device 800 may include a capacitive array of electrodes or nodes that operate in accordance with a mutual-capacitance or self-capacitance scheme. The touch sensor 820 may be integrated with one or more layers of a display stack (e.g., the display 109) to provide the touch-sensing functionality of a touchscreen. Moreover, the touch sensor 820, or a portion thereof, may be used to sense motion of a user's finger as it slides along a surface of a crown, as described herein.

The device 800 may also include a force sensor 822 that is configured to receive and/or detect force inputs applied to a user input surface of the device 800 (e.g., the display 109). The force sensor 822 may use or include capacitive sensors, resistive sensors, surface acoustic wave sensors, piezoelectric sensors, strain gauges, or the like. In some cases, the force sensor 822 may include or be coupled to capacitive sensing elements that facilitate the detection of changes in relative positions of the components of the force sensor (e.g., deflections caused by a force input). The force sensor 822 may be integrated with one or more layers of a display stack (e.g., the display 109) to provide force-sensing functionality of a touchscreen.

The device 800 may also include a communication port 828 that is configured to transmit and/or receive signals or electrical communication from an external or separate device. The communication port 828 may be configured to couple to an external device via a cable, adaptor, or other type of electrical connector. In some embodiments, the communication port 828 may be used to couple the device 800 to an accessory, including a dock or case, a stylus or other input device, smart cover, smart stand, keyboard, or other device configured to send and/or receive electrical signals.

As described above, one aspect of the present technology is the gathering and use of data available from various sources to improve the usefulness and functionality of devices such as mobile phones. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to locate devices, deliver targeted content that is of greater interest to the user, or the like. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings. Also, when used herein to refer to positions of components, the terms above, below, over, under, left, or right (or other similar relative position terms), do not necessarily refer to an absolute position relative to an external reference, but instead refer to the relative position of components within the figure being referred to. Similarly, horizontal and vertical orientations may be understood as relative to the orientation of the components within the figure being referred to, unless an absolute horizontal or vertical orientation is indicated.

Features, structures, configurations, components, techniques, etc. shown or described with respect to any given figure (or otherwise described in the application) may be used with features, structures, configurations, components, techniques, etc. described with respect to other figures. For example, any given figure of the instant application should not be understood to be limited to only those features, structures, configurations, components, techniques, etc. shown in that particular figure. Similarly, features, structures, configurations, components, techniques, etc. shown only in different figures may be used or implemented together. Further, features, structures, configurations, components, techniques, etc. that are shown or described together may be implemented separately and/or combined with other features, structures, configurations, components, techniques, etc. from other figures or portions of the instant specification. Further, for ease of illustration and explanation, figures of the instant application may depict certain components and/or sub-assemblies in isolation from other components and/or sub-assemblies of an electronic device, though it will be understood that components and sub-assemblies that are illustrated in isolation may in some cases be considered different portions of a single electronic device (e.g., a single embodiment that includes multiple of the illustrated components and/or sub-assemblies).

What is claimed is:

1. An electronic watch comprising:
a housing member defining a hole along a side surface of the housing member;
a haptic button comprising:
an input member positioned at least partially within the hole and defining an input surface;
a magnet configured to generate a magnetic field; and
a conductive coil coupled to the input member and positioned at least partially within the magnetic field; and
a processing unit configured to cause an electrical current to pass through the conductive coil, thereby moving the input member along a translation direction perpendicular to the input surface to produce a haptic output.

2. The electronic watch of claim 1, wherein:
the magnet defines an internal structure; and
the electronic watch further comprises a compliant member defining a portion positioned between the input member and the internal structure and configured to deform in response to a force input applied to the input member.

3. The electronic watch of claim 2, wherein:
the portion of the compliant member is a first portion; and
the compliant member further defines a second portion defining a periphery of the haptic button and in contact with a surface of the hole, thereby defining a seal between the haptic button and the housing member.

4. The electronic watch of claim 1, wherein:
the electronic watch further comprises:
a display; and
a transparent cover over the display and coupled to the housing member;
the processing unit is further configured to detect a force input applied to the input member; and
the haptic output is produced in response to the detection of the force input.

5. The electronic watch of claim 4, wherein:
the input member is configured to move in response to the force input, thereby causing the conductive coil to move within the magnetic field to induce an electrical signal in the conductive coil; and
the processing unit is configured to:
detect the electrical signal; and
in accordance with the electrical signal satisfying a condition, initiate the haptic output.

6. The electronic watch of claim 1, further comprising an internal structure coupled to the input member and defining a retention feature configured to receive a fastener for attaching the haptic button to the housing member.

7. The electronic watch of claim 1, wherein the conductive coil is fixed to an interior surface of the input member.

8. A portable electronic device comprising:
a housing member;
a display;
a transparent cover over the display and coupled to the housing member; and
an input device configured to receive an input and produce a haptic output, the input device positioned at least partially in a hole defined through a side of the housing member and comprising:
an internal structure comprising a magnet configured to generate a magnetic field;
an input member defining an input surface of the input device;
a compliant member positioned between the input member and the internal structure and configured to deform in response to the input and in response to the haptic output; and
a conductive coil configured to interact with the magnetic field to move the input member relative to the internal structure to produce the haptic output.

9. The portable electronic device of claim 8, wherein the compliant member attaches the input member to the internal structure.

10. The portable electronic device of claim 8, wherein:
the input is a translational input; and
the input member moves relative to the internal structure along a translation direction perpendicular to the input surface in response to the translational input.

11. The portable electronic device of claim 10, wherein moving the input member relative to the internal structure to produce the haptic output comprises moving the input member along the translation direction.

12. The portable electronic device of claim 8, wherein the portable electronic device is configured to:
detect a characteristic of the input; and
in accordance with the characteristic of the input satisfying a condition, supply an electrical current to the conductive coil to produce a force on the input member to produce the haptic output.

13. The portable electronic device of claim 12, wherein detecting the characteristic of the input comprises detecting an electrical signal induced in the conductive coil due to the conductive coil moving in the magnetic field.

14. The portable electronic device of claim 12, wherein the characteristic of the input is at least one of a force of the input or a translation distance of the input.

15. A wearable electronic device comprising:
a housing;
a touch-sensitive display coupled to the housing and configured to receive a touch input and provide a graphical output; and
a crown positioned along a side of the housing and comprising:
a body structure;
a cap structure coupled to the body structure and defining an exterior end surface of the crown;
a magnet configured to generate a magnetic field; and
a coil coupled to the cap structure and configured to interact with the magnetic field to impart a force on the cap structure, thereby moving the cap structure relative to the body structure to produce a haptic output.

16. The wearable electronic device of claim 15, wherein the body structure of the crown defines at least a portion of a peripheral exterior surface of the crown.

17. The wearable electronic device of claim 16, further comprising a sensing system configured to detect movement of a finger along the peripheral exterior surface of the crown.

18. The wearable electronic device of claim 17, wherein:
the sensing system comprises an optical sensing component configured to detect the movement of the finger along the peripheral exterior surface of the crown; and
the optical sensing component is mounted on the magnet.

19. The wearable electronic device of claim 15, wherein:
the cap structure is coupled to the body structure via a compliant member; and
the compliant member deforms when the cap structure is moved relative to the body structure.

20. The wearable electronic device of claim 19, wherein:
the cap structure is configured to move relative to the body structure in response to a force input being applied to the cap structure, thereby causing the coil to move in the magnetic field;
the wearable electronic device is configured to detect the force input based at least in part on a change in an electrical characteristic of the coil resulting from the coil moving in the magnetic field; and
the haptic output is produced in response to detecting the force input.
